(19) United States
(12) Patent Application Publication
(10) Pub. No.: US 2023/0222846 A1
(43) Pub. Date: Jul. 13, 2023

(54) TASK MANAGING SYSTEM FOR TESTING-CONFIGURING VEHICLES BASED ON A TASK ORDER AND METHOD THEREOF

(71) Applicant: Ford Global Technologies, LLC, Dearborn, MI (US)

(72) Inventors: Jeffrey Daugherty, Canton, MI (US); John Cardillo, Windsor (CA); Priyank Shah, West Bloomfield, MI (US); Basavaraj Tonshal, Northville, MI (US); Jesudoss Daniel, Kanata (CA); Christina Metcalf, Wixom, MI (US); Jamal Alezzani, Belleville, MI (US)

(73) Assignee: Ford Global Technologies, LLC, Dearborn, MI (US)

(21) Appl. No.: 17/572,818

(22) Filed: Jan. 11, 2022

(51) Int. Cl. G07C 5/00; G06F 9/48; G06F 9/38

(52) U.S. Cl. CPC G07C 5/008; G06F 9/4881; G06F 9/3836

(57) ABSTRACT

A task managing system (TMS) test-configures one or more vehicles based on a task order for a selected vehicle from a vehicle management system (VMS). The TMS includes a plurality of task execution controllers configured to communicate with the vehicle. The TMS further includes a processor configured to execute instructions stored in a nontransitory computer-readable medium to operate as a task delegation module and a task status module. The task delegation module is configured to assign a selected vehicle from among the one or more vehicles to a selected task execution controller, where the selected task execution controller is configured to execute the task order for the selected vehicle. The task status module is configured to monitor a status of the task order being executed by the selected task execution controller based on an update message from the selected task execution controller.

### CROSS-REFERENCE TO RELATED APPLICATIONS

This application is related to copending applications filed concurrently herewith titled “VEHICLE MANAGING SYSTEM FOR MANAGING VEHICLES TO BE TESTED-CONFIGURED AND METHOD THEREOF” and “TASK MANAGING SYSTEM HAVING MULTIPLE TASK EXECUTION CONTROLLERS FOR TESTING-CONFIGURING VEHICLES AND METHOD THEREOF,” which are commonly assigned with the present application and the contents of which are incorporated herein by reference in their entireties.

### FIELD

The present disclosure relates to a system and method for testing and configuring one or more vehicles.

### BACKGROUND

The statements in this section merely provide background information related to the present disclosure and may not constitute prior art.

Vehicles typically go through various testing and system configurations during their life. For example, over the years, vehicle manufacturing facilities have conducted end-of-line diagnostic testing and system configuration on vehicles. To conduct such tasks, a diagnostic tool is physically positioned and located at the end of the manufacturing line and, using a tethered approach, an operator physically plugs the diagnostic testing tool into a connector of a vehicle. Communicating with a vehicle communication network (e.g., CAN or LIN), the diagnostic tool executes tests and software configurations within a period of time. This approach provides a one diagnostic tool to a one vehicle configuration.

The tethered approach typically provides a limited number of diagnostic tools, which in turn limits the number of vehicles that can be processed during a given period of time. Additionally, due to each tool being physically positioned at the end of the line, the testing and configuration can be limited to the end of the manufacturing line. These issues related to vehicle diagnostics and system configurations, among other issues related to testing and configuring vehicle are addressed by the present disclosure.

### SUMMARY

This section provides a general summary of the disclosure and is not a comprehensive disclosure of its full scope or all of its features.

In one form, the present disclosure is directed to a task managing system for testing-configuring one or more vehicles based on a task order for a selected vehicle from a vehicle management system (VMS). The task managing system includes a plurality of task execution controllers configured to communicate with the one or more vehicle. The task managing system further includes a processor configured to execute instructions stored in a nontransitory computer-readable medium to operate as a task delegation module and a task status module. The task delegation module is configured to assign a selected vehicle from among the one or more vehicles to a selected task execution controller from among the plurality of task execution controllers, where the selected task execution controller is configured to execute the task order for the selected vehicle. The task order defines one or more software-based tasks to be performed on the selected vehicle. The task status module is configured to monitor a status of the task order being executed by the selected task execution controller based on an update message from the selected task execution controller.

In some forms, the task delegation module is further configured to assign the selected vehicle and the task order to the selected task execution controller based on availabilities of the plurality of task execution controllers, the task order, or a combination thereof. In some forms, the processor is further configured to operate as an error control module configured to monitor a wireless communication link between the selected vehicle and the selected task execution controller to determine whether the wireless communication link between the selected vehicle and the selected task execution controller is abnormal. The error control module is further configured to perform a corrective action in response to the wireless communication link being abnormal. In some forms, in response to the wireless communication link being abnormal, the error control module is further configured to select another task execution controller from among the plurality of task execution controllers, as the selected task execution controller to execute the task order. In some forms, the processor is further configured to operate as an error control module, where the error control module is configured to execute a corrective action in response to an error notification from at least one task execution controller of the plurality of task execution controllers. In some forms, in response to an error notification from the selected task execution controller, the error control module is further configured to select another task execution controller from among the plurality of task execution controllers, as the selected task execution controller to execute the task order. In some forms, the task status module is configured to transmit a query to the selected task execution controller to receive the update message. In some forms, the task status module periodically receives the update message from the plurality of task execution controllers. In some forms, the task status module is configured to generate a report selected from among a plurality of reports, where the plurality of reports provides information related to the execution of the task order, capacity of the plurality of task execution controllers, projection of task order execution timing, projection of task order execution capacity, or a combination thereof. In some forms, the processor is further configured to operate as a role determination module configured to, identify the VMS as a primary VMS or an auxiliary VMS based on information from the VMS and stored VMS identification information. the role determination module is configured to permit communication with the VMS in response to the VMS being the primary VMS, and issue a role notification to the VMS in response to the VMS being the auxiliary VMS, in which the role notification identifies the VMS as the auxiliary VMS.

In one form, the present disclosure provided a method for testing-configuring one or more vehicles by a task managing system based on a task order for a selected vehicle from a vehicle management system (VMS). The task managing system includes a plurality of task execution controllers configured to communicate with the one or more vehicles The method includes obtaining, by the task managing system, the task order for the selected vehicle from the VMS and assigning, by the task managing system, the task order to a selected task execution controller from among a plurality of task execution controllers. The selected task execution controller is configured to execute the task order for the selected vehicle. The task order defines one or more software-based tasks to be performed on the selected vehicle. The method further includes monitoring, by the task managing system, a status of the task order being executed by the selected task execution controller based on an update message from the selected task execution controller.

In some forms, the task order is assigned by the task managing system to the selected execution controller based on availabilities of the plurality of task execution controllers, the task order, or a combination thereof. In some forms the method further includes monitoring, by the task managing system, a wireless communication link between the selected vehicle and the selected task execution controller to determine whether the wireless communication link between the selected vehicle and the selected task execution controller is abnormal, and performing, by the task managing system, a corrective action in response to the wireless communication link being abnormal. In some forms the method further includes selecting by the tasking managing system, another task execution controller from among the plurality of task execution controllers, as the selected task execution controller to execute the task order in response to the wireless communication link being abnormal. In some forms the method further includes executing, by the tasking managing system, a corrective action in response to an error notification from at least one task execution controller of the plurality of task execution controllers. In some forms in response to the error notification from the selected task execution controller, the method further includes selecting, by the tasking managing system, another task execution controller from among the plurality of task execution controllers, as the selected task execution controller to execute the task order. In some forms, the method further includes, periodically receiving, by the task managing system, the update message from the task execution controller. In some forms, the method further includes generating, by the task managing system, a report selected from among a plurality of reports, in which the plurality of reports provides information related to the execution of the task order, capacity of the plurality of task execution controllers, projection of task order execution timing, projection of task order execution capacity, or a combination thereof. In some forms, the method further includes, identifying, by the task managing system, the VMS as a primary VMS or an auxiliary VMS based on information from the VMS and stored VMS identification information. The method further includes permitting, by the task managing system, communication with the VMS in response to the VMS being the primary VMS. The method further includes issuing, by the task managing system, an auxiliary identifier notification to the VMS in response to the VMS being the auxiliary VMS, where the auxiliary identifier notification identifies the VMS as the auxiliary VMS.

In one form, the present disclosure is directed to a task managing system for testing-configuring one or more vehicles based on a task order for a selected vehicle from a vehicle management system (VMS). The task managing system includes a plurality of task execution controllers configured to wirelessly communicate with one or more vehicles, and a processor configured to execute instructions stored in a nontransitory computer-readable medium to operate as a task delegation module, a task status module, and an error control module. The task delegation module is configured to assign a selected vehicle from among the one or more vehicles to a first task execution controller from among the plurality of task execution controllers, as the selected task execution controller, based on availabilities of the plurality of task execution controllers, the task order, or a combination thereof. The selected task execution controller is configured to execute the task order for the selected vehicle, where the task order defines one or more software-based tasks to be performed on the selected vehicle and includes a diagnostic control, a vehicle system configuration, or a combination thereof. The task status module is configured to monitor a status of the task order being executed by the selected task execution controller based on an update message from the selected task execution controller. The error control module is configured to monitor a wireless communication link between the selected vehicle and the selected task execution controller to determine whether the wireless communication link between the selected vehicle and the selected task execution controller is abnormal, and in response to the wireless communication link being abnormal, the error control module is further configured to select a second task execution controller from among the plurality of task execution controller, as the selected task execution controller to execute the task order. In response to an error notification from the first task execution controller, the error control module is further configured to select a third task execution controller from among the plurality of task execution controllers, as the selected task execution controller to execute the task order.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 illustrates an example system in communication with multiple vehicles and devices, in accordance with the teachings of the present disclosure;

FIG. 2 is a block diagram of an example task managing system of the system, in accordance with the teachings of the present disclosure; and

FIG. 3 is a flowchart of an example task control routine, in accordance with the present disclosure; and

FIG. 4 is a flowchart of an example error control routine, in accordance with the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Vehicles may be equipped with wireless communication devices that establish wireless communication links with external devices that may perform diagnostics, tests, software configuration, among other tasks. In a non-limiting example, such a wireless communication link may be based on diagnostic over internet protocol (DoIP). Execution of the various tasks can be challenging due to, for example, the number of vehicles, the different types of vehicles, the variation in tasks to be performed, among other factors.

The present disclosure provides a system for automatically scheduling and executing defined tasks for respective vehicles using wireless communication. More particularly, the system includes a vehicle management system (VMS) for identifying the vehicles and a task managing system (TMS) for executing tasks defined in a task order provided by the VMS for a selected vehicle. More particularly, the TMS includes a task scheduling controller (TSC) and multiple task execution controllers (TEC). The TECs are configured to wirelessly communicate with the vehicles and execute the tasks for a respective vehicle. The TSC is configured to assign the selected vehicle to a selected TEC and monitor a status of the task order being executed by the selected task execution controller based on information from the selected TEC. The system of the present disclosure provides automatic allocation of network resources to execute tasks on multiple vehicles if desired. Additionally, the TSC monitors the execution of the tasks and the health of the communication link between the vehicles and respective TECs to responsively address the issue and reduce or inhibit delays in the execution of the tasks.

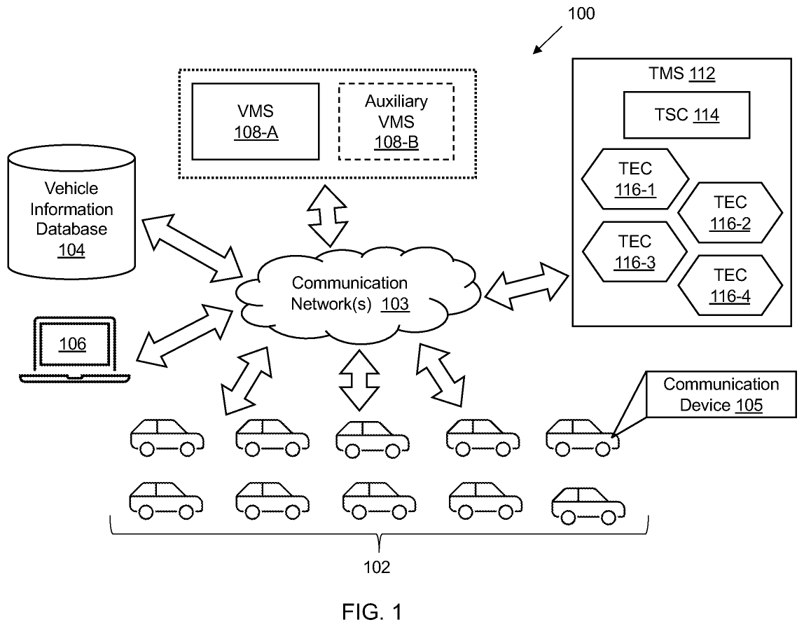

Referring to FIG. 1, the present disclosure provides an example system 100 configured to communicate with one or more vehicles 102 to execute a defined set of software based tasks on the vehicle 102. In a non-limiting example, the tasks may include vehicle software configuration, vehicle software configuration updates, tests, and/or diagnostics, among other tasks. More particularly, in an example application, vehicles 102 provided in a manufacturing facility are configured to communicate with the system 100 via one or more communication networks 103 that employs wireless and/or wired communication links. Various wireless communication links may be employed such as, but not limited to, transmission control protocol (TCP), internet protocol (IP), cellular protocols, among others. In a non-limiting example, in using TCP/IP, the vehicle 102 are configured to employ diagnostic over internet protocol (DoIP). Accordingly, the vehicles 102 and the system 100 include software and/or hardware components (e.g., routers, transmitters, microprocessors, antenna, memory, interface ports, among other devices) for establishing the communication link. In addition, the facility may include gateway servers, routers, transmitters, antenna, interface ports, among other components for supporting the communication network 103. It should be readily understood that the system 100 for testing-configuring the vehicles 102 may be employed in other applications, such as at a vehicle service facility, and should not be limited to a manufacturing facility.

In one form, each vehicle 102 includes a communication device 105 that is configured to communicate with external devices via wired and/or wireless communication using one or more of the communication methods described above. The communication device 105 is configured to broadcast an introduction signal that includes data to uniquely identify the vehicle. In a non-limiting example, the data can include a vehicle identifier for the vehicle (e.g., a vehicle identification number (VIN)), an entity identification (EID), a communication identification (e.g., IP address). In one form, the communication device 105 is further configured to communicate with other devices/modules within the vehicle 102 via a vehicle communication network (not shown), such as a local Interconnect network (LIN) or a controller area network (CAN). Accordingly, the system 100 is able to establish a communication link with the vehicle 102 to manage and execute defined set of tasks for the vehicle 102, as described herein.

In addition to the vehicle 102, the system 100 is in communication with a vehicle information database 104 that stores information associated with the vehicles 102 via the communication network 103. More particularly, in one form, the vehicle information database 104 is configured to store the vehicle identifier and corresponding task order for each of the vehicles 102. In one form, the task order includes information related to the selected vehicle (e.g., the vehicle identifier, vehicle make, vehicle model, vehicle year, among other information) and one or more tasks to be performed on the vehicle 102.

In one form, a user may communicate with the system 100 via a computer 106 that is in communication with the system 100 via the communication networks 103. Accordingly, the user is able track the progress of the vehicle 102 and tasks being performed. In addition, the system 100 is able to notify the user of any errors.

In one form, the system 100 includes a vehicle managing system (“VMS”) 108 (VMS 108-A and 108-B in FIG. 1) and a task managing system (TMS) 112. In an example application, the system 100 having the VMS 108 and the TMS 112 includes one or more servers provided at the same or distributed at different locations (e.g., via one or more edge computing devices) and communicably coupled accordingly.

When employing wired communication, the system 100 can further include an input-output interface (not show) that provides a wired communication link between the vehicles 102 and the system 100. For example, the input-output interface may be provided as a dongle attached to the OBD port of the vehicle 102, where the dongle communicates with the system 100. In another example, the input-output interface is a series of ports to be connected to the vehicle 102 via a cable. The input-output interface is communicably coupled to the VMS 108. In one form, once connected via wired communication, the VMS 108 is configured to identify the vehicle 102, as described herein, and the vehicle 102 may then communicate with the system 100 using wireless communication to have the various tasks performed thereon. In another example, the vehicle 102 and the system 100 including the VMS 108 may communicate only through a wireless communication link.

The VMS 108 is configured to communicate with the vehicles 102 and the TMS 112 to assign the vehicles 102 to the TMS 112, which is configured to perform designated tasks associated with each of the vehicles. An example of such a VMS is disclosed in Applicant's co-pending application titled “VEHICLE MANAGING SYSTEM FOR MANAGING VEHICLES TO BE TESTED-CONFIGURED AND METHOD THEREOF,” which is commonly owned with the present application and the contents of which are incorporated herein by reference in its entirety. As described, the VMS 108 is configured to scan for the introduction signal from the vehicles 102 and identify the vehicle broadcasting the introduction signal, using the vehicle identifier and the information in the vehicle information database 104. The VMS 108 stores and manages an inventory of the data from the vehicles 102, such as the vehicle identifiers and the communication address (e.g., IP addresses) in a database. Once identified, the VMS 108 acquires the task order for the selected vehicle and transmits a request to the TMS 112 to have the TMS 112 execute the task order. In one form, the request includes the vehicle identifier, the communication address, and the tasks to be performed for the selected vehicle. Once transmitted, the TMS 112 may update the VMS on the execution of the tasks, the operation state of the TMS 112, among other information. Based on the updates received, the VMS may notify a user via the computer 106 and/or store date regarding the report in the database.

In some forms, the system 100 includes two or more VMSs 108-A and 108-B, where one VMS is provided as a primary VMS (e.g., VMS 108-A) and the other VMS(s) are auxiliary VMS (e.g., VMS 108-B). The primary VMS communicates with the vehicle 102 and assigns the task orders. The auxiliary VMS(s) does not communicate with the vehicles 100 until the respective auxiliary VMS is identified as the new primary VMS when the original primary VMS is deactivated due to abnormal operation, health-maintenance check, or other suitable condition in which the original primary VMS cannot perform its duties. As described herein, each VMS 108 is configured to have a VMS identification (ID) information, which is used to determine whether the VMS 108 is a primary VMS or an auxiliary VMS. The VMS ID information is a unique identifier assigned to the VMS 108, and may include, but not limited to, a communication address (e.g., IP address) of the VMS 108, a character string associated with the physical device of the VMS 109, other type of identifier. In some applications, the VMS 108 may confer whether the respective VMS 108 is a primary VMS or an auxiliary VMS by transmitting a role ID message having the VMS ID information for the respective VMS 108 to the TMS 112. In response to the role ID message, as described below, the TMS 112 transmits a role notification to the VMS 108 which identifies the respective VMS as a primary or an auxiliary. While the system 100 of FIG. 1 is illustrated as having two VMS, it should be readily understood that the system 100 may include one or more VMSs.

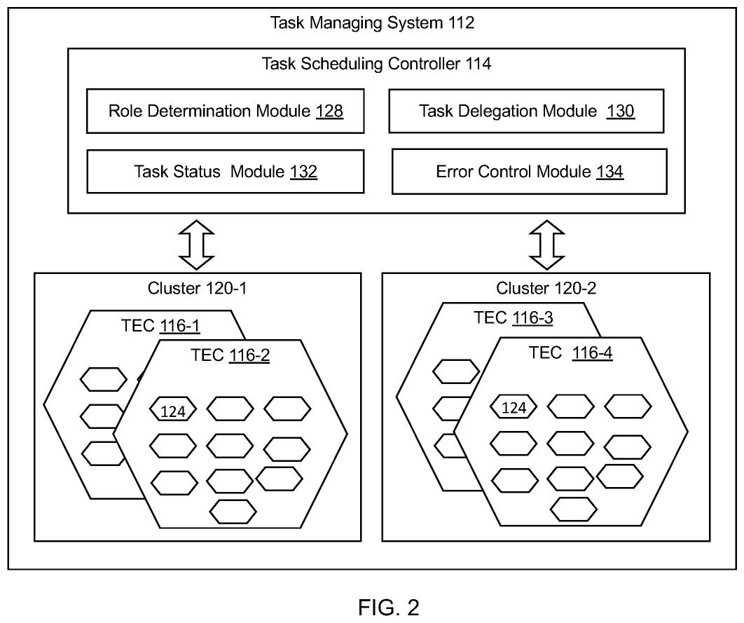

With additional reference to FIG. 2, in one form, the TMS 112 includes a task scheduling controller 114 and a plurality of task execution controllers (TEC) 116-1 to 116-4 (collectively “TEC 116”). While four TECs are illustrated, the TMS 112 may include any number of TECs (i.e., 2 or more). In addition, in an example application, the TECs 116 may be grouped in clusters 120-1 and 120-2 (collectively “clusters 120”), where each cluster 120 includes at least two TECs 116 provided in a machine unit (e.g., a server). In one form, each TEC 116 includes a set of communication nodes 124 (i.e., one or more nodes), where each communication node 124 is configured to communicate with a respective vehicle. Thus, a single TEC 116 is able to communicate with multiple vehicles to execute respective task orders for the vehicles 102.

An example of such a TEC is disclosed in Applicant's co-pending application titled “TASK MANAGING SYSTEM HAVING MULTIPLE TASK EXECUTION CONTROLLERS FOR TESTING-CONFIGURING VEHICLES AND METHOD THEREOF,” which is commonly owned with the present application and the contents of which are incorporated herein by reference in its entirety. The TEC 116 is configured to execute the tasks in the task order received and also provide updates to the TSC 114 regarding the tasks being performed. For example, the TEC 116 may transmit an update message to the TSC 114 providing information related to status of the task(s) being performed, such as: percent completion of the task and/or task order; an error associated with the execution of a task (e.g., a diagnostic test indicating an error or a software configuration not being completed). The TEC 116 may also provide information related to the operation state (i.e., health check) of the TEC 116 such as a faulty communication node or circuitry. As described herein, the TSC 114 performs a corrective action to address the faulty TEC 116.

The TSC 114 is configured to assign the task order of a selected vehicle 102 to a selected TEC 116 from the plurality of TECs 116 to have the selected TEC 116 execute the task order on the selected vehicle 102. In one form, the TSC 114 includes a role determination module 128, a task delegation module 130, a task status module 132, and an error control module 134.

The role determination module 128 is configured to register a communication address of the VMS 108 requesting communication and inform the VMS 108 of its current role status such as a primary VMS or an auxiliary VMS. The role status of a VMS 108 determines whether the role determination module will permit further communication with the VMS 108. In one form, the role determination module 128 is configured to store the VMS ID information associated with the one or more VMS(s) 108 to identify and authorize future communications from the requesting VMS 108. More particularly, the role determination module 128 stores the VMS ID information of a primary VMS, which may be identified by a user via the computer 106 or assigned by the role determination module 128. For example, if no VMS ID information is stored for the primary VMS, the role determination module 128 identifies a first VMS 108 that communicates with the role determination module 128 as the primary VMS and stores the VMS ID information of the first VMS in, for example, cache employed for the primary VMS. The other VMS(s) 108 that communicate with the role determination module 128 are identified as auxiliary VMS(s), and the VMS ID information are stored as auxiliary VMS(s) in another cache. Other storing or registering methods may be used for storing the VMS ID information and identifying the VMS as primary or auxiliary.

In response to the role ID message from the VMS 108, the role determination module 128 determines whether the message is from a primary VMS or auxiliary VMS based on the VMS ID information stored for the primary VMS. For example, the role determination module 128 compares the IP address (i.e., VMS ID information) provided in the role ID message with the IP address of the identified primary VMS. If there is a match, the role determination module 128 identifies the VMS 108 as the primary VMS and transmits a role notification indicating such determination to the VMS 108 that sent the message. In addition, the role determination module 128 permits communication with the identified primary VMS 108. If the IP address from the VMS 108 does not match the information stored for the identified primary VMS, the role determination module 128 determines the VMS 108 is an auxiliary VMS. In some applications, the role determination module 128 further compares the IP address to the IP addresses of identified auxiliary VMS(s). If there is a match, the role determination module 128 transmits a role notification indicating such determination to the VMS of the original message. If there is no match, the role determination module 128 registers/stores the IP address of the VMS as an auxiliary VMS, and transmits the role notification indicating the VMS is an auxiliary to the VMS that sent the original message. In addition, the role determination module 128 inhibits communication with the auxiliary VMS by, for example, not processing messages from the auxiliary VMS.

In one form, the task delegation module 130 is configured to receive the request to assign the task order associated with the selected vehicle 102 from the VMS 108 and based on availabilities of the TECs, assign the task order to a selected TEC 116. More particularly, in an example application, the request from the VMS 108 directs the task status module 132 to fetch task data identifying the tasks to be performed from an identified cache based on the vehicle identifier of the selected vehicle. In one example, the task data includes a list of tasks in a schema file, where the tasks are identified by a task identifier. In one example, the task delegation module 130 receives a request to fetch the task data associated with the vehicle 102 and retrieves the task data from the vehicle information database 104.

To assign the selected vehicle 102 to a TEC 116, the task delegation module 130 is configured to determine which TECs 116 of the plurality of TECs 116 are available to perform the tasks. For example, the task delegation module 130 is configured to periodically send an availability status request to each TEC 116. The TEC 116 in return provides data indicating the available and/or unavailable communication nodes 124 of the TEC 116. In lieu of transmitting a status request, the task delegation module 130 may periodically receive the status updates from the TECs 116.

Based on the availabilities, the task delegation module 130 is configured to assign the task order based on a defined set of rules. In one example, the defined set of rules may provide that the task delegation module 130 assigns the task order to a first selected TEC 116 prior to assigning the task order to another TEC 116. That is, if a first TEC 116 has one communication node 124 available, whereas a second TEC 116 has multiple communication nodes 124 available, the task delegation module 130 assigns the task order to the first TEC 116 so that all of its communication nodes 124 are processing task orders before assigning to the second TEC 116. In another example, the task delegation module 139 may assign the task order based on a number of available communication nodes associated with a TEC 116. Specifically, if a first TEC 116 has one busy communication node 124 and a second TEC 116 has all available communication nodes 124, the task delegation module 130 assigns the task order to a first communication node 124 of the second TEC 116 prior to assigning another task order to a second communication of the first TEC 116. In one form, to assign the task order, the task delegation module 130 transmits a message that includes data related to the task order (e.g., tasks to be executed) and the selected vehicle (e.g., vehicle identifier, communication address) to the selected TEC 116. It should readily understood that other defined rules may be employed for assigning the task order based on the availabilities of the TEC 116.

The task status module 132 is configured to monitor and track a status of the task order being executed by the selected TEC 116 based on an update message received from the selected TEC 116. In one form, the task status module 132 transmits a query to the selected TEC 116 to receive the update message. Alternatively, the task delegation module 130 may automatically receive the update message from the selected TEC 116 without transmitting the query. In another example, the task order being executed may include checkpoints which identifies the completion of a task, of a portion of a task, and/or of the task order. Accordingly, the task status module 132 receives the update message when the selected TEC 116 reaches a checkpoint associated with the task order. The task delegation module 130 is configured to store the update messages in a local cache for the selected vehicle. In one form, the update message includes data indicative of the vehicle identifier of the selected vehicle 102, an identification of the selected TEC, an identification of the selected communication node, the task order, a checkpoint, and/or a task status (e.g., tasks completed, percent completed, among other methods for indicating task status).

Based on the update message(s), the task status module 132 is configured to generate a report that provides information related to the execution of the task order, capacity of the TECs 116, and/or timing projection of task order execution (e.g., start and/or completion of the tasks). The task delegation module 130 is configured to store the reports in the local cache. For example, at least one report is a foresight report that includes information related to, but not limited to, how may vehicles have completed task orders by the system, how many vehicles have been completed by a selected TEC 116, how much time was spent on each vehicle, and/or completion time for a given task.

The error control module 134 is configured to monitor, identify, and track errors associated with the TMS 112, and perform a corrective action to have the TMS 112 execute task orders on the vehicles 102. In one example, the error control module 134 is configured to monitor a wireless communication link between the selected vehicle 102 and the selected TEC 116 to assess the quality of the wireless communication link, or more particularly, determine whether the wireless communication link between the selected vehicle 102 and the selected TEC 116 is abnormal. In one form, the quality of the wireless communication link may be related to a signal strength. For instance, the error control module 134 may have the selected TEC 116 provide data on how long it takes the selected vehicle 102 to respond to the TEC 116. That is, the error control module 134 transmits a message requesting the TEC 116 to ping the selected vehicle 102 and measure the response time. If a response time of the vehicle 102 is greater than a defined threshold, the error control module 134 determines that the wireless communication link is abnormal (e.g. slow, intermittent, jammed, loss), and performs a corrective action. In another example, the quality of the wireless communication link is based on whether a communication gap exists between the selected vehicle 102 and the selected TEC 116. A communication gap is determined based on bandwidth usage, data packets, performance metrics, or a combination thereof between the selected vehicle 102 and the selected TEC 116. The error control module 134 may assess the quality of the wireless communication link based on a quality request from a user via the computer 106 or may periodically check the quality based on data from the TEC(s) 116.

In one form, the error control module 134 is further configured to receive and address an error notification from a TEC 116 (i.e., a faulty TEC). The error notification may indicate a faulty circuit, one or more faulty communication nodes 124, or the like associated with the TEC 116. In one form, the error control module 134 is configured to query each of the TECs 116 to determine whether the TEC 116 is operable. For example, the error control module 134 pings each of the TECs 116 for a health check and waits for a predetermined period of time for a response. If the TEC 116 does not respond within the predetermined period of time, the error control module 134 determines that the TEC 118 is not operating as expected (i.e., a faulty TEC 116) and performs a corrective action.

In another example, the error control module 134 is configured to determine an error condition when a TEC 116 fails to respond to a request from the task delegation module 130. Specifically, if the task delegation module 130 does not receive a response from the TEC 116, the error control module 134 identifies the TEC 116 as being a faulty TEC and performs a corrective action.

In response to the error in the communication quality and/or a faulty TEC, the error control module 134 performs one or more corrective actions such as, but not limited to: reassigning the selected vehicle and task order to another TEC 116, transmitting an error notification message to the VMS 108; generating and storing a report including information regarding the error (e.g., wireless communication link being abnormal of the faulty TEC), where the report may be accessible by the user via the computer; providing an error alert (e.g., audible notification and/or visual notification received at the location having the TEC 115 and/or the computer 106; and/or for a faulty TEC 116, flagging/tagging the faulty TEC 116 with an error code indicating the TEC 116 as being faulty and thus, not to be assigned a task order. The report includes information to identify the selected vehicle and the select TEC 116, and may include communication address of the vehicle, the vehicle identifier of the selected vehicle 102, an ID information of the TEC 116, an error description, severity of the error alert, manual intervention required tag, and/or a recommendation to manage error alert.

The error control module 134 is configured to clear or remove the error label associated with a faulty TEC 116 once the error has been resolved. For example, after flagging the faulty TEC 116, if the TEC 116 responds within allotted time period to a subsequent communication request, the error control module 134 may remove the error label. In another example, the user may manually remove the error label via the computer. In yet another example, after sending an error notification, the faulty TEC 116 may transmit another message indicating that the operation state of the TEC 16 is normal and no faults detected. In response to such a message, the error control module may remove the error label and begin to assign tasks orders to the TEC 116.

In one form, the error control module 134 is configured to monitor health and performance metrics of the VMS 108 to determine whether the VMS 108 is operating as expected. For example, the error control module 134 may receive an error notification from the VMS 108 indicating that the VMS 108 is faulty due to a hardware and/or software related issue. In another example, the error control module 134 periodically pings the VMS 108 to request a health update (e.g., a response signal) and/or a performance metrics update (e.g., a defined report providing VMS ID information, metrics on number of vehicles processed, among other information). If a health update/performance metric is not provided within a predetermined time, the error control module 134 is configured to identify the VMS as being abnormal and assigns an auxiliary VMS as the new primary VMS. Other corrective actions similar to those described above with respect to the TEC 116 may also be performed, such as notifying the user of the faulty VMS 108.

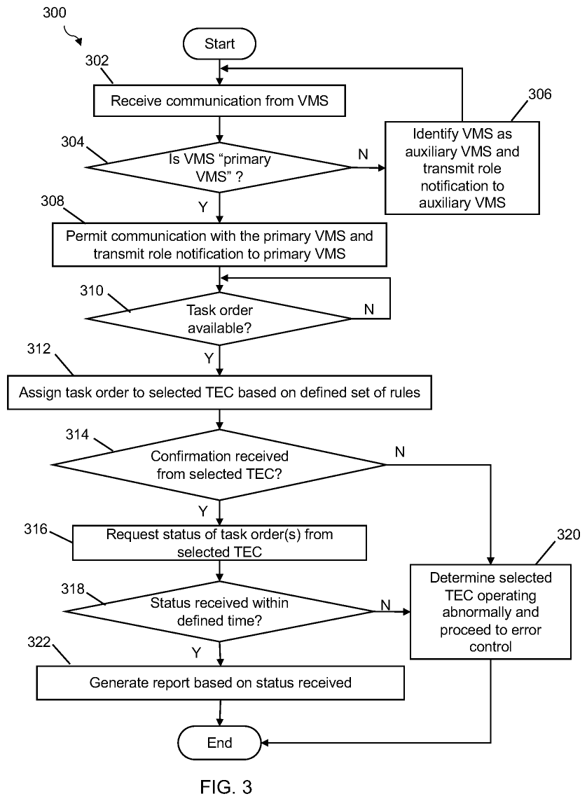

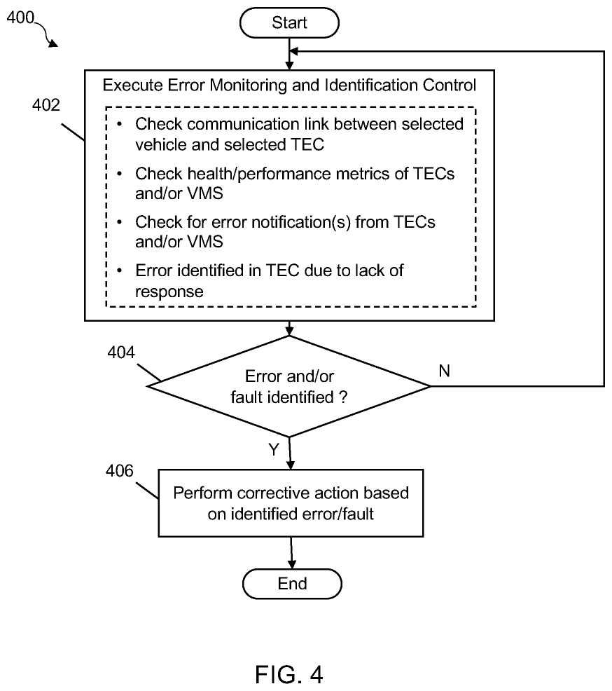

With reference to FIGS. 3 and 4, an example task control routine 300 and error control routine 400 performed by the TSC 114 is provided. At 302, the TMS 112 receives a communication (e.g., a request to communicate or role ID message), from a VMS and determines whether the VMS is the primary VMS, at 304. For example, as provided above, the communication includes a VMS ID information of the sender and the TSC compares the information to stored VMS ID information for the primary VMS. If the VMS ID information does not match, the TSC identifies the VMS as an auxiliary VMS and transmits the role notification to the VMS that sent the communication, at 306. If the VMS ID information does match, the VMS that sent the communication is the primary VMS, and the TSC allows additional messages from the primary VMS and transmits the role notification to the VMS, at 308. While not illustrated in FIG. 3, if no VMS ID information is stored for the primary VMS, then there is no primary VMS, and the TSC identifies and registers the VMS that sent the communication as the primary VMS.

At 310, the TSC determines whether a task order is available from the primary VMS and waits until a task order is available. If the task order is available, the TSC selects a TEC based on defined set of rules (e.g., rules based on availabilities of the TECs), and assigns the task order to the selected TEC (e.g., transmits a message to the TEC with the task order), at 312. At 314, the TSC determines whether a confirmation is received from the TEC, and if no confirmation is received, the routine goes to 320. If a confirmation is received, the TSC requests a status of the task order being executed by the selected TEC, at 316. For example, the TSC requests status from each TEC performing task orders, where a given TEC may be executing multiple task order for multiple vehicles.

At 319, the TSC determines whether the status is received from the selected TEC and if no status is received, the TSC proceeds to 320. if the status information is received, the TEC generates a report based on the status information received from the selected TEC(s), at 322. The report can be stored by the TSC and accessible by a user via the computer 106. The report may also be provided the VMS. At 320, the TSC determines that the selected TEC is operating abnormally since the TEC is not responsive to the TSC, and proceeds to the error control of FIG. 4 to address the abnormal operation.

Referring to FIG. 4, in the error control routine 400, the TSC executes one or more error monitoring and identification control, at 402. As described above, the controls may include, but is not limited to: checking communication link between selected vehicle and selected TEC; checking health/performance metrics of TECs and/or VMS; checking for error notifications from TECs and/or VMS; and/or checking for error identified in TEC due to lack of response. At 404, the TSC determines if an error and/or fault is detected, and at 406 performs a corrective action based on identified error and fault.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A task managing system for testing-configuring one or more vehicles based on a task order for a selected vehicle from a vehicle management system (VMS), the task managing system comprising:
a plurality of task execution controllers configured to communicate with the one or more vehicles; and
a processor configured to execute instructions stored in a nontransitory computer-readable medium to operate as:
a task delegation module configured to assign a selected vehicle from among the one or more vehicles to a selected task execution controller from among the plurality of task execution controllers, wherein the selected task execution controller is configured to execute the task order for the selected vehicle, wherein the task order defines one or more software-based tasks to be performed on the selected vehicle; and
a task status module configured to monitor a status of the task order being executed by the selected task execution controller based on an update message from the selected task execution controller.

2. The task managing system of claim 1, wherein the task delegation module is further configured to assign the selected vehicle and the task order to the selected task execution controller based on availabilities of the plurality of task execution controllers, the task order, or a combination thereof.

3. The task managing system of claim 1, wherein the processor is further configured to operate as an error control module configured to:
monitor a wireless communication link between the selected vehicle and the selected task execution controller to determine whether the wireless communication link between the selected vehicle and the selected task execution controller is abnormal; and
perform a corrective action in response to the wireless communication link being abnormal.

4. The task managing system of claim 3, wherein, in response to the wireless communication link being abnormal, the error control module is further configured to select another task execution controller from among the plurality of task execution controllers, as the selected task execution controller to execute the task order.

5. The task managing system of claim 1, wherein the processor is further configured to operate as an error control module, wherein the error control module is configured to execute a corrective action in response to an error notification from at least one task execution controller of the plurality of task execution controllers.

6. The task managing system of claim 5, wherein in response to an error notification from the selected task execution controller, the error control module is further configured to select another task execution controller from among the plurality of task execution controllers, as the selected task execution controller to execute the task order.

7. The task managing system of claim 1, wherein the task status module is configured to transmit a query to the selected task execution controller to receive the update message.

8. The task managing system of claim 1, wherein the task status module periodically receives the update message from the plurality of task execution controllers.

9. The task managing system of claim 1, wherein the task status module is configured to generate a report selected from among a plurality of reports, wherein the plurality of reports provides information related to the execution of the task order, capacity of the plurality of task execution controllers, projection of task order execution timing, projection of task order execution capacity, or a combination thereof.

10. The task managing system of claim 1, wherein the processor is further configured to operate as a role determination module configured to:
identify the VMS as a primary VMS or an auxiliary VMS based on information from the VMS and stored VMS identification information;
permit communication with the VMS in response to the VMS being the primary VMS; and
issue a role notification to the VMS in response to the VMS being the auxiliary VMS, wherein the role notification identifies the VMS as the auxiliary VMS.

11. A method for testing-configuring one or more vehicles by a task managing system based on a task order for a selected vehicle from a vehicle management system (VMS), the task managing system including a plurality of task execution controllers configured to communicate with the one or more vehicles, the method comprising:
obtaining, by the task managing system, the task order for the selected vehicle from the VMS;
assigning, by the task managing system, the task order to a selected task execution controller from among the plurality of task execution controllers, wherein the selected task execution controller is configured to execute the task order for the selected vehicle, and the task order defines one or more software-based tasks to be performed on the selected vehicle; and
monitoring, by the task managing system, a status of the task order being executed by the selected task execution controller based on an update message from the selected task execution controller.

12. The method of claim 11, wherein the task order is assigned by the task managing system to the selected execution controller based on availabilities of the plurality of task execution controllers, the task order, or a combination thereof.

13. The method of claim 11 further comprising:
monitoring, by the task managing system, a wireless communication link between the selected vehicle and the selected task execution controller to determine whether the wireless communication link between the selected vehicle and the selected task execution controller is abnormal; and
performing, by the task managing system, a corrective action in response to the wireless communication link being abnormal.

14. The method of claim 13 further comprising selecting by the tasking managing system, another task execution controller from among the plurality of task execution controllers, as the selected task execution controller to execute the task order in response to the wireless communication link being abnormal.

15. The method of claim 11 further comprising executing, by the tasking managing system, a corrective action in response to an error notification from at least one task execution controller of the plurality of task execution controllers.

16. The method of claim 15 further comprising in response to the error notification from the selected task execution controller, selecting, by the tasking managing system, another task execution controller from among the plurality of task execution controllers, as the selected task execution controller to execute the task order.

17. The method of claim 11 further comprising periodically receiving, by the task managing system, the update message from the task execution controller.

18. The method of claim 11 further comprising generating, by the task managing system, a report selected from among a plurality of reports, wherein the plurality of reports provides information related to the execution of the task order, capacity of the plurality of task execution controllers, projection of task order execution timing, projection of task order execution capacity, or a combination thereof.

19. The method of claim 11 further comprising:
identifying, by the task managing system, the VMS as a primary VMS or an auxiliary VMS based on information from the VMS and stored VMS identification information;
permitting, by the task managing system, communication with the VMS in response to the VMS being the primary VMS; and
issuing, by the task managing system, an auxiliary identifier notification to the VMS in response to the VMS being the auxiliary VMS, wherein the auxiliary identifier notification identifies the VMS as the auxiliary VMS.

20. A task managing system for testing-configuring one or more vehicles based on a task order for a selected vehicle from a vehicle management system (VMS), the task managing system comprising:
a plurality of task execution controllers configured to wirelessly communicated with the one or more vehicles; and
a processor configured to execute instructions stored in a nontransitory computer-readable medium to operate as:
a task delegation module configured to assign a selected vehicle from among the one or more vehicles to a first task execution controller from among the plurality of task execution controllers, as the selected task execution controller, based on availabilities of the plurality of task execution controllers, the task order, or a combination thereof, wherein the selected task execution controller is configured to execute the task order for the selected vehicle, wherein the task order defines one or more software-based tasks to be performed on the selected vehicle and includes a diagnostic control, a vehicle system configuration, or a combination thereof;
a task status module configured to monitor a status of the task order being executed by the selected task execution controller based on an update message from the selected task execution controller;
an error control module configured to:
monitor a wireless communication link between the selected vehicle and the selected task execution controller to determine whether the wireless communication link between the selected vehicle and the selected task execution controller is abnormal, and
in response to the wireless communication link being abnormal, the error control module is further configured to select a second task execution controller from among the plurality of task execution controller, as the selected task execution controller to execute the task order; and
in response to an error notification from the first task execution controller, the error control module is further configured to select a third task execution controller from among the plurality of task execution controllers, as the selected task execution controller to execute the task order.
